(19) United States
(12) Patent Application Publication
(10) Pub. No.: US 2009/0216566 A1
(43) Pub. Date: Aug. 27, 2009

(54) Systems and Methods for Management of Compensation and Benefit Plans

(76) Inventor: Robert Thompson, Harrison, NY (US)

Correspondence Address: MCDERMOTT WILL & EMERY LLP, 600 13TH STREET, N.W., WASHINGTON, DC, 20005-3096, US

(21) Appl. No.: 12/390,966

(22) Filed: Feb. 23, 2009

Related U.S. Application Data
(60) Provisional application No. 61/066,722, filed on Feb. 22, 2008.

(51) Int. Cl. G06Q 40/00

(52) U.S. Cl. 705/4; 705/37

(57) ABSTRACT

The present inventions provide systems and methods that allow employees to electively participate in an alternate compensation and benefits arrangement, such as a specialized statutory trust structure, which provides the same or substantially similar benefits as their employer's deferred compensation plan without the employer being exposed to the additional cost and reporting burdens imposed by the new or existing reporting and administrative rules.

### PRIORITY CLAIM

This application claims priority from U.S. provisional application Ser. No. 61/066,722 filed Feb. 22, 2008.

### BACKGROUND OF THE INVENTION

The present invention relates to a leveraged bonus financing arrangement involving employee and independent contactor compensation and benefit programs, and more particularly to systems and methods of reducing the costs of and financing of such programs.

Employers, whether corporations, professional partnerships or other entities, have traditionally provided deferred compensation plans, such as supplemental retirement plans, to partners, key employees, and other highly compensated individuals within their business structure. However, recent changes in reporting requirements driven by various agencies of federal government have drastically increased the cost and complexity of administering and reporting these assets which are considered “on balance sheet” assets. Such requirements have made employers reluctant to continue to offer deferred compensation and significantly reduced employee benefits traditionally associated with such plans. Nevertheless, employees and employers alike would like to maintain such compensation plans in view of the significant benefit they provide.

Accordingly, a need exists for systems and methods which allow employees to maintain their compensation plans with the same or substantially similar benefits without being exposed to the additional cost and reporting burdens imposed by the new regulations.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a block diagram illustrating the systems and methods of the present invention.

FIG. 2 is a flow chart illustrating some of steps involved in the present invention.

### SUMMARY OF THE INVENTION

The present inventions provide systems and methods that allow employees to electively participate in an alternate compensation and benefits arrangement, such as a specialized statutory trust structure, which provides the same or substantially similar benefits as their employer's deferred compensation plan without the employer being exposed to the additional cost and reporting burdens imposed by the new or existing reporting and administrative rules.

In one embodiment of the present invention, a method for administering a specialized trust plan with respect to a leveraged bonus or compensation arrangement is provided, comprising: creating a series trust, wherein each series in the series trust has substantially no economic relationship to any other series in the series trust; accepting an asset contribution from a participant of the specialized trust plan and allocating the contribution to a first series in the series trust; optionally lending the participant funds for use as additional asset contributions to the first series; and investing the first series asset contributions on behalf of the participant.

Another aspect of the present invention is directed toward a computer-readable medium having stored thereon a plurality of sequences of instructions including sequences of instructions which, when executed by one or more processors cause an electronic device to create a series trust, wherein each series in the series trust has substantially no economic relationship to any other series in the series trust; accept an asset contribution from a participant of the specialized trust plan and allocating the contribution to a first series in the series trust; optionally lend the participant funds for use as additional asset contributions to the first series; and invest the first series asset contributions on behalf of the participant.

### DETAILED DESCRIPTION OF INVENTION

It is contemplated that the subject matter described herein may be embodied in many forms. Accordingly, the embodiments described in detail below are the presently preferred embodiments, and are not to be considered limitations.

One aspect of the present invention is concerned with providing systems and methods that allow employees to electively participate in an alternate compensation and benefits arrangement, such as a specialized statutory trust structure, which provides the same or substantially similar benefits as their employer's deferred compensation plan without the employer being exposed to the additional cost and reporting burdens imposed by the new or existing reporting and administrative rules.

Generally speaking, one way this may be accomplished is by moving the assets in the employer's deferred compensation plan to the specialized trust structure which is administrated by a management entity that is not controlled or substantially affiliated with the employer. With this approach, previously aggregated deferred compensation assets may be transferred to this separate and substantially independent management entity for management and administration. Employees may deal directly with this management entity after the transfer, which relieves the employer from management and reporting responsibilities mandated by various regulations while still allowing the employees to receive the same or substantially similar benefits form the independent management entity. Certain specific embodiments of systems and methods that achieve in accordance with present invention are described below.

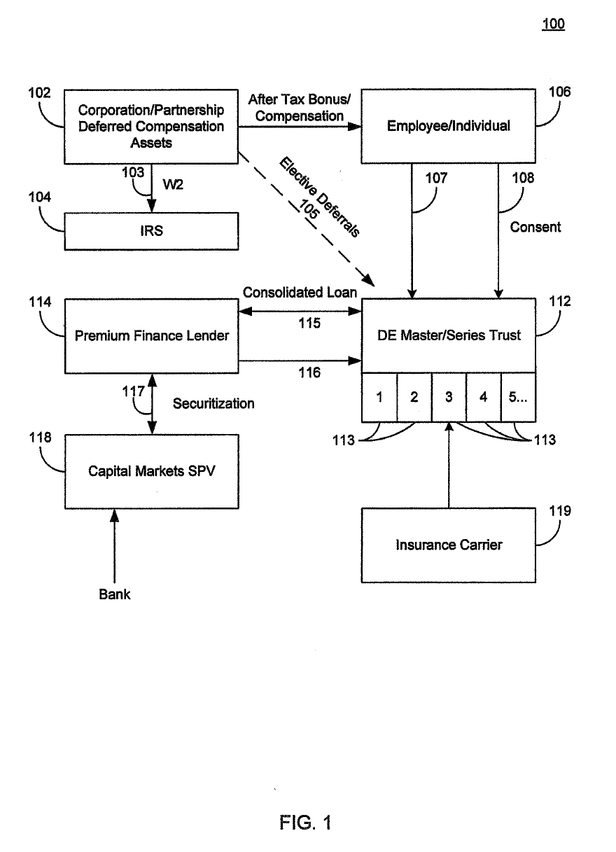

FIG. 1 is a block diagram 100 illustrating one possible specific embodiment of the invention. Associated with a given corporation or partnership are deferred compensation plan assets 102. These plans may be nonqualified and use either company money (SERP) and/or employee money (deferred compensation) which may provide an employee a choice of a lump sum or a series of payouts at retirement (or as allowed by law).

As shown in FIG. 1, the company may divest itself of plan assets 102 by terminating the benefit plan and disbursing assets 102 to participants 106. In cases where there is no pre-existing plan, assets may be directly provided to employees, who may electively transfer those funds to a trust as further described herein. Assets 102 are preferably, but not necessarily, distributed to participants 106 after tax obligations (if any) are satisfied through a W2 report, payment, or other compliant action 103 to IRS 104. This relieves the employer from the regulatory and/or administrative expense or responsibility associated with the pre-existing benefit plan.

Using the systems and methods described herein, employees may continue to receive the same or similar benefits previously provided (or administered) by their employer. For example, participants 106 may transfer their assets 102 to a specialized trust 112 such as a Delaware Master Series Trust, established and managed by a benefit administrator not affiliated with the participants employer (referred to herein as the “trust administrator”). Each participant 106 may be assigned a different series number in trust 112 and assets received from each participant 106 are assigned to the corresponding series 113 in trust 112.

Thus, each series 113 in trust 112 represents the assets 102 of a particular participant 106. Due to the nature of specialized trust 112, each series 113 has substantially no economic relationship to any other series 113 (e.g., when created under Delaware law as Delaware Master Series Trust, or any other specialized trust with similar features—there is substantially no economic relationship among series). Accordingly, there is no cross-default or cross-collateralization exposure between series or trusts.

One benefit of this arrangement is that it protects the assets of each series 113 (and therefore each participant 106) from cross default, cross-collateralization or risk sharing with different series 113 in trust 112. As a result, any assets or liability attributable to a certain series 113 have no affect on the assets of another series 113 and vice versa. This allows the trust administrator to deal with each series 113 (and thus each participant 106) individually and independently without affecting other trust participants. The absence of cross-default or cross-collateralization risk between series permits a series 113 to acquire of one or more life insurance policies on the life of a participant 106 connected to such series in compliance with state insurance laws.

Participants 106 may transfer their after tax compensation or other assets via conduit 107 and execute the necessary management and consent documents 108 which are also transferred to trust 112. Such consent documents may include agreements granting the trust administrator the right to manage the trust and make certain decisions, which may, in some embodiments, include investment decisions on behalf of participants 106 (through series 113). In one embodiment, the trust administrator may purchase life insurance on behalf of any given participant 106 (e.g., through the participant's associated series 113). The trust administrator may charge an administration fee for such services.

In many instances, however, assets 102 represent pre-tax money that has been invested on a pre-tax basis. When assets 102 are distributed, the tax on the distributions become due. Some or all participants 106, however, may wish to continue to grow their assets 102 on a pre-tax equivalent basis. In this case, according to one embodiment of the invention, participants 106 may pay taxes to IRS 104 in accordance with legal requirements. However, the trust administrator may offer to obtain a premium finance loan from a lender substantially equal to the tax value paid to the IRS by the participant secured by the assets of his or her series 113. This allows a participant 106 to continue to participate on a pre-tax equivalent value basis subject to interest charges owed to the trust administrator.

In other embodiments, however, loans may be obtained for amounts greater than of less than that of the tax value paid, depending on various factors, such as approval by the lender for such amounts, and/or the financial goals of the participant or trust administrator, etc.

Next, participant 106 may then contribute the after tax compensation and the amount of the premium finance loan to his or her respective series 113 in trust 112. Series 113 may then use the proceeds to acquire one or more life insurance policies on the life of participant 106. The beneficiaries of series 113 may then be selected by the participant 106. The beneficiaries of series 113 will have an insurable interest in the life of participant 106.

With this approach, certain other terms may be imposed in the consent documents 108. For example, the premium finance lender may place a lien on the series 113 in an amount corresponding to the loan obtained by the trust related to such that any disbursements or amounts payable from that series 113 to the series beneficiaries are subordinate to the principal and interest amount owed to the premium finance lender. Moreover, in order to continue to enjoy the benefit on a going forward basis, each participant 106 may continue to pledge funds directly to their respective series 113.

In this case, participant 106 may pay taxes on the contributed funds, and the series continues to obtain loans as needed and 113 to cover the tax amounts paid. The interest on these loans continues to accrue and may be paid in one lump sum prior to a liquidation of that series 113 or may be paid periodically to the trust administrator.

Where the transferred funds are used to purchase life insurance, the insurance is preferably a permanent universal life insurance policy obtained from recognized insurance carrier 119. When the insured dies (or other qualifying event is triggered, such as the retirement of the participant), the proceeds of the life insurance policy may be paid to the premium finance lender who holds a collateral assignment with respect to the life insurance policy. Any remaining amounts may then be returned to trust 112 for distribution to the participant 106 and/or the series designated beneficiaries.

In other embodiments, where trust 112 obtains the loans (e.g., as described below), the proceeds of the life insurance policy may be paid to trust 112 (not shown). In this case, trust 112 has an obligation to pay the lender 114 the remaining principal and any outstanding interest. Any remaining amounts may then distributed by trust 112 to participant 106 and/or the series designated beneficiaries.

In order to finance the loans issued to the series 113, the trust administrator may seek funding from a premium finance lender 114. However, rather than seek funding on a series by series basis, and pay higher interest rates for small loans, the trust administrator may seek funding on behalf of the trust 112 in the aggregate, thereby minimizing interest rates. For example, the trust administrator may seek a $1 M loan at premium rate, and allocate those funds to each series 113 as needed (e.g., based on the pre-tax equivalent level). In some embodiments, the trust administrator, in addition to receiving upfront management fees from each participant, may increase the interest rate over LIBOR (e.g., 50-200 basis points) to generate additional money over and above the management fees.

Thus, the premium finance lender 114 loans money to trust 112 as the legal borrower, but with the economic liability under loan 115 and the assets which serve as collateral both allocated to each respective series 113 as appropriate, individual by individual. As mentioned above, each series is preferably compartmentalized such that no series 113 is cross-defaulted or cross-collateralized with any other series 113.

During the normal course of operation, premium finance lender 114 may receive loan documentation, loan disbursements, collections, surrenders, etc. from trust 112. However, any legal or collection actions against trust 112 would be generally limited to proceeding against only the relevant series 113 for cause. Thus, a default on the part of an individual participant 106 would cause lender 114 to proceed only against the assets held by the relevant participant's series 113. Moreover, because of the relatively high level of collateral available for trust 112, lender 114 can relatively easily securitize the loans through the commercial paper, asset backed securities or medium term note market through a bankruptcy remote special purpose vehicle 118.

By way of example of the above, assume a corporation has 500 participants 106, (e.g., defined as employees or associates who are insurable and willing to participate) each receiving a bonus of $100,000 per year. Each participant 106 determines how much of the $100,000 to contribute, execute all relevant paperwork 108 relating to insurance, consents, etc. Upon execution, the corporation (i) issues a bonus $100,000 to each participant, generating a compensation expense; (ii) withholds all relevant taxes as appropriate (e.g., $40,000); and (iii) contributes, per the written instructions of each participant, the after tax net bonus proceeds of $60,000 per participant into the appropriate series 113.

Lender 114, having fully documented the financing arrangement with respect to trust 112, would make a $2 M loan disbursement to the trust 112 (equal to $40,000 per participant 106). Trust 112 then allocates $40,000 loan to each series and tracks the interest due on each series 113. In this case, each series will have $100,000 to pay premiums on life insurance policies on the lives of the respective participants.

Computer Implementation

In some embodiments, some or all aspects of the disclosed invention may be implemented in software and performed by one or more computers, so as to more effectively and efficiently establish and/or administer particular aspects of the invention. For example, given the large size of potential participants 106, and the number of factors involved in managing participants, handling fund transfers, establishing the appropriate trust(s), securing life insurance, managing the associated trusts including life insurance and beneficiary payments, and reporting to participants, it may be impractical for most if not all of such tasks to be performed manually.

Accordingly, some or all of the aspects of the inventions described herein may be performed by a computer and computer code therefor, including establishing and maintaining the compensation and benefit plan 100 described herein. Such software and any associated data may be created, customized and/or maintained and managed by lender 114 and/or the trust administrator. In some embodiments, this effort may be coordinated or sponsored by the participant's employer.

For example, one or more computer programs may be developed, in the form of source and/or executable code and be disposed on computer readable medium such as a CD ROM, jump drive, or other magnetic or optical storage media for performing or implementing any of the features described herein. Such computer code may also be disposed on a local or personal computer, a network computer or on a remote computer such a server as part of a distributed network such as a WAN or LAN for a certain entity, etc.

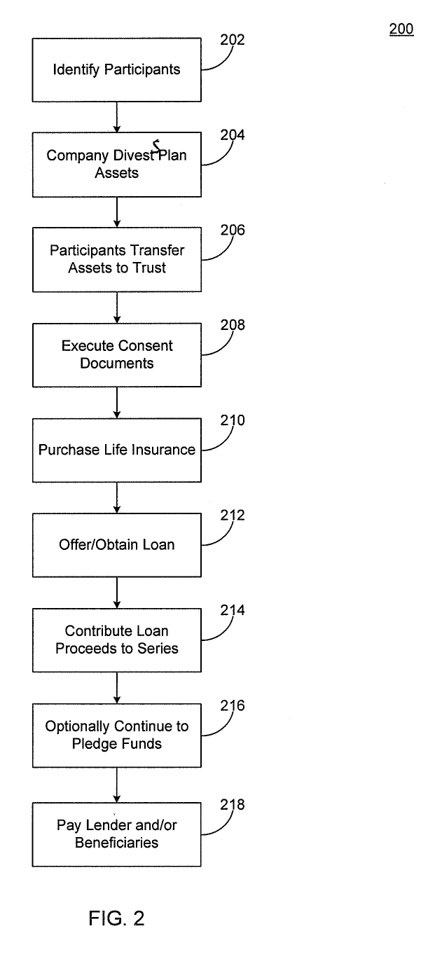

FIG. 2 is a flow chart 200 representing some of the steps that may be performed by a computer and through one or more application programs in accordance with the principles of the present invention.

At step 202, in some embodiments, certain information regarding potential participants, such as demographic information and other personal information such as health information, and insurance information, may be obtained and entered into a database, etc. Such information may already be present in an existing database relating to the benefit plan or other employer database. In this case, the existing database may be used, if desired. This information on the group and/or group members is optionally evaluated to determine which employees qualify as participants in the program. In other embodiments, only a list of approved participants, and any associated information, is provided.

As shown in FIG. 2, the company may divest itself of plan assets at step 204 by terminating the benefit plan and disbursing assets 102 to participants 106. Assets 102 are preferably, but not necessarily, distributed to participants 106 after tax obligations (if any) are satisfied through a W2 report, payment, or other compliant action 103 to IRS 104. This relieves the employer from the regulatory and/or administrative expense or responsibility associated with the pre-existing benefit plan.

At step 206, participants 106 may transfer their assets 102 to a specialized trust 112 such as a Delaware Master Series Trust, established and managed by a benefit administrator not affiliated with the participants employer. Each participant 106 may be assigned a different series number in trust 112 and assets received from each participant 106 are assigned to the corresponding series 113 in trust 112. Thus, each series 113 in trust 112 represents the assets 102 of a particular participant 106.

At step 208, if required, participants may execute the necessary management and consent documents 108 which are also transferred to trust 112. Next, at step 210, the trust administrator may purchase life insurance on behalf of any given participant 106 (e.g., through the participant's associated series 113). The trust administrator may charge an administration fee for such services and/or provide other services further described herein.

If the transferred assets are post-tax assets, the trust administrator may offer to obtain a premium finance loan from a lender substantially equal to the tax value paid to the IRS by the participant secured by the assets of his or her series 113 (step 212). This allows a participant 106 to continue to participate on a pre-tax equivalent value basis subject to interest charges owed to the trust administrator.

It will be understood, however, that in other embodiments, loans may be obtained for amounts greater than or less than that of the tax value paid, depending on various factors, such as approval by the lender for such amounts, and/or the financial goals of the participant or trust administrator, etc. (not shown).

At step 214, participants 106 may then contribute the after tax compensation and the amount of any loan to his or her respective series 113 in trust 112. Series 113 may then use the proceeds to acquire one or more life insurance policies on the life of participant 106. The beneficiaries of series 113 may then be selected by participant 106. The beneficiaries of series 113 will have an insurable interest in the life of participant 106.

Moreover, in order to continue to enjoy the benefit on a going forward basis, each participant 106 may optionally continue to pledge funds to directly to their respective series 113 (step 216). In the case where the transferred funds are used to purchase life insurance, the insurance is preferably a permanent universal life insurance policy obtained from recognized insurance carrier 119. When the insured dies (or other qualifying event is triggered, such as the retirement of the participant), the proceeds of the life insurance policy may be paid to the premium finance lender who holds a collateral assignment with respect to the life insurance policy (step 218). Any remaining amounts may then be returned to trust 112 for distribution to the participant 106 and/or the series designated beneficiaries.

In other embodiments, where trust 112 obtains the loans, the proceeds of the life insurance policy may be paid to trust 112 (not shown). In this case, trust 112 has an obligation to pay the lender 114 the remaining principal and any outstanding interest. Any remaining amounts may then distributed by trust 112 to participant 106 and/or the series designated beneficiaries.

Although certain specific embodiments of the present invention have been disclosed, it is noted that the present invention may be embodied in other forms without departing from the spirit or essential characteristics thereof. The present embodiments are therefore to be considered in all respects as illustrative and not restrictive, the scope of the invention being indicated by the appended claims, and all changes that come within the meaning and range of equivalency of the claims are therefore intended to be embraced therein.

What is claimed is:

1. A method for administering a specialized trust plan with respect to a leveraged bonus or compensation arrangement, comprising:
creating a series trust, wherein each series in the series trust has substantially no economic relationship to any other series in the series trust;
accepting an asset contribution from a participant of the specialized trust plan and allocating the contribution to a first series in the series trust;
optionally lending the participant funds for use as additional asset contributions to the first series; and
investing the first series asset contributions on behalf of the participant.

2. The method of claim 1 wherein the series trust is a Delaware Series Trust.

3. The method of claim 1 wherein investing further includes procuring life insurance for the participant.

4. The method of claim 1 further comprising the series trust borrowing funds from a lender to lend to the participant.

5. The method of claim 4 wherein the series trust lends to the participant at an interest rate higher than that charged by the lender.

6. The method of claim 1 further comprising an employer divesting participant assets.

7. The method of claim 1 further comprising distributing invested asset contributions upon the occurrence of a trigger event.

8. The method of claim 1 wherein distributing invested asset contributions further comprises paying off a loan made to the participant.

9. The method of claim 4 wherein distributing invested asset contributions further comprises paying off a loan made to the series trust.

10. The method of claim 8 wherein distributing invested asset contributions further comprises distributing excess funds to the participant or designated beneficiary.

11. The method of claim 7 wherein the trigger event is retirement or death of the participant.

12. A computer-readable medium having stored thereon a plurality of sequences of instructions including sequences of instructions which, when executed by one or more processors cause an electronic device to:
create a series trust, wherein each series in the series trust has substantially no economic relationship to any other series in the series trust;
accept an asset contribution from a participant of the specialized trust plan and allocating the contribution to a first series in the series trust;
optionally lend the participant funds for use as additional asset contributions to the first series; and
invest the first series asset contributions on behalf of the participant.

13. The computer-readable medium of claim 12 wherein the series trust is a Delaware Series Trust.

14. The computer-readable medium of claim 12 wherein investing further includes procuring life insurance for the participant.

15. The computer-readable medium of claim 12 further comprising the series trust borrowing funds from a lender to lend to the participant.

16. The computer-readable medium of claim 15 wherein the series trust lends to the participant at an interest rate higher than that charged by the lender.

17. The computer-readable medium of claim 12 further comprising an employer divesting participant assets.

18. The computer-readable medium of claim 12 further comprising distributing invested asset contributions upon the occurrence of a trigger event.

19. The computer-readable medium of claim 12 wherein distributing invested asset contributions further comprises paying off a loan made to the participant.

20. The computer-readable medium of claim 19 wherein distributing invested asset contributions further comprises paying off a loan made to the series trust.

21. The computer-readable medium of claim 19 wherein distributing invested asset contributions further comprises distributing excess funds to the participant or designated beneficiary.

22. The computer-readable medium of claim 18 wherein the trigger event is retirement or death of the participant.
